(19) United States
(12) Patent Application Publication
(10) Pub. No.: US 2011/0037562 A1
(43) Pub. Date: Feb. 17, 2011

(54) OUTDOOR VENDING MACHINE AND USE OF A USER INTERFACE FOR THE OPERATION OF AN OUTDOOR VENDING MACHINE

(75) Inventors: Erwin Braukmann, Wolfratshausen (DE); Oliver Graebner, Muenchen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Muenchen (DE)

(21) Appl. No.: 12/988,215

(22) PCT Filed: Mar. 25, 2009
(86) PCT No.: PCT/EP2009/053509

§ 371 Date: Oct. 15, 2010

(30) Foreign Application Priority Data
Apr. 18, 2008 (DE) 10 2008 019 642.8

(51) Int. Cl. G06F 7/02

(52) U.S. Cl. 340/5.9

(57) ABSTRACT

An outdoor vending machine in the form of a parking meter includes the following elements: a user interface having a cover plate, there being disposed in the region thereof operating information items and force sensors coupled to the cover plate, the force sensors outputting signals as a function of an external force exerted on the sensors via the cover plate, analysis electronics having a pressure point determination unit for ascertaining pressure points on the cover plate based on the signals of the force sensors, an association unit, which associates different operator commands with different pressure points in operation, and a processing unit; which carries out sales actions in operation based on the operator commands. The operating information items include operator command information items which are at least partially localized in or on a pressure area on the cover plate. Activation in the pressure area is accomplished by touching a pressure point to which the association unit assigns operator commands corresponding to the operator command information items. There is also provided a user interface for an outdoor vending machine.

The present invention relates to an outdoor vending machine and to the use of a user interface for the operation of an outdoor vending machine.

In comparison to vending machines which are set up within enclosed spaces, it should be noted when operating outdoor vending machines that they have to be protected against adverse influences in many respects: firstly, this relates to weather influences, for example the effects of moisture and damp, and secondly outdoor vending machines particularly also have to be protected against vandalism since they are more difficult to monitor than indoor vending machines and are therefore at a greater risk of being damaged by actions of force. The user interfaces, which can be used by users to perform a sales transaction, are particularly sensitive in this respect. Therefore, in the case of outdoor vending machines, there is a tendency to keep such user interfaces as small as possible and to allow a user to perform only a small number of possible actions on the user interface. Secondly, it is also desirable in the case of outdoor vending machines to firstly provide a user with as much information as possible and secondly to allow as many different action options as possible during the sales process.

Therefore, in the case of the majority of outdoor vending machines, the input options are substantially restricted to so-called pushbuttons which are embedded in a touch panel and consist of moveable metal plates within the touch panel. The user information on such devices is usually realized by displays and/or printed descriptions at present. A user operates the machine by means of push-Buttons; the inputs of these pushbuttons are processed by means of a processor unit and control, for example, the displayed content in the display. One disadvantage of these arrangements is that the pushbuttons can be manufactured in a country-, language- and customer-specific manner only with considerable outlay on production. In addition, it not possible for any desired number of pushbuttons to be connected to a processor unit. New concepts in user control and country-, language- and customer-specific adaptations can therefore be implemented only with difficulty in the case of such vending machines which are known at present.

The invention is based on the object of providing an outdoor vending machine which is as secure against vandalism as possible and with the aid of which improved and simplified user control is made possible, in particular as a result of it being possible to adapt the user interface in a country-, language- and/or customer-specific manner.

According to the invention, this object is achieved by an outdoor vending machine having
a user interface with a cover plate in the region of which operator control information items and force sensors which are coupled to the cover plate are arranged, said force sensors emitting signals as a function of an external force which is exerted on said force sensors by means of the cover plate,
an evaluation electronics system with a pressure point determination unit for identifying pressure points on the cover plate on the basis of the signals from the force sensor,
an assignment unit which assigns different operator commands to different pressure points during operation, and
a processing unit which executes sales actions during operation on the basis of the operator commands,
with the operator control information items comprising operator command information items, which are in each case at least partly located in or on a pressure region on the cover plate, by a pressure point being activated by touch, the assignment unit assigning operator commands which correspond to the operator command information items to said pressure point.

Within the scope of the invention, all vending machines which are equipped and/or intended for outdoor use are defined as “outdoor vending machines”. Therefore, an outdoor vending machine can be also arranged within enclosed spaces in the case of a special application, for example a parking ticket machine within a parking garage. In this case, it is critical that the equipment components of the vending machine make it possible for the vending machine to be suitable for being set up outside enclosed spaces without additional equipment components. Vending machines include all machines from which sales articles and/or services of value can be acquired, that is to say beverage and food machines and also parking ticket machines, cash machines, stamp machines, machines for charging prepayment cards and similar machines.

An outdoor vending machine can be designed to be virtually completely secure against vandalism by said outdoor vending machine having a vandal-proof cover plate. This is primarily achieved by the selection of a suitable material and thickness of the cover plate and additionally by stable attachment of the cover plate to the housing of the machine.

Therefore, a vandal-proof cover plate is coupled to force sensors in accordance with the invention. Force sensors of this kind can be, for example, spring-based sensors or electrical or electronic pressure or tension sensors, preferably piezo elements or else, for example, suitable organic sensors. For example, a capacitor arrangement with an interposed dielectric can be designed such that the dielectric can be compressed when pressure is exerted and, as a result, a measurable change in capacitance is produced.

When selecting the force sensors, it is critical only that they emit signals as a function of the force exerted on them. Using the evaluation electronics system and the pressure point determination unit integrated in said evaluation electronics system, that point at which the force has been exerted on the cover plate can be identified on the basis of these signals. Operator commands are assigned to the pressure points with the aid of the assignment unit. These operator commands correspond directly to the operator command information items which form at least part of the operator control information items. The operator control information items are again at least partly arranged in the region of the cover plate. This means that they can be arranged completely in this region or else partly, for example, in the form of symbols or suitably marked subregions in the region of the cover plate and an associated legend in an information region provided elsewhere.

Therefore, the user interface together with the subordinate evaluation, assignment and processing elements is formed such that a user can identify, on the basis of the operator control information, that region of the cover plate in which it has to exert a force in order to activate an operator command which produces the desired result during the sales process.

This sales process is initiated by means of the signals from the force sensors in the form of operator commands which are assigned to different pressure points. In contrast to conventional outdoor vending machines in which a force can be exerted only on individual operator control elements, such as pushbuttons, in this case the entire cover plate therefore serves as an input interface for haptic interaction between the vending machine and a user. An action of force, for example by the actions of vandals, is included in the calculation by the selection of the suitable cover plate and does not put the entire system at risk.

The invention also comprises the use of a user interface having a cover plate in the region of which operator control information items and force sensors which are coupled to the cover plate are arranged, said force sensors emitting signals as a function of an external force which is exerted on said force sensors by means of the cover plate, and having an evaluation electronics system with a pressure point determination unit for identifying pressure points on the cover plate on the basis of the signals from the force sensors, for the operation of an outdoor vending machine, preferably a parking ticket machine.

The use of an interface of this kind for parking ticket machines or for designing a vending machine as a parking ticket machine are above all particularly suitable for this because parking ticket machines are usually extremely susceptible to vandalism and at the same time user control which is easy to understand is required. Parking ticket machines can also be used in an internationally standardized manner and, for this reason, the particular advantages of the invention can be found in this area.

Further particularly advantageous refinements and developments of the invention can be gathered from the dependent claims and the following description, where the use of a user interface can also be developed for outdoor vending machines in accordance with the dependent claims.

One particularly advantageous refinement of the invention is that the cover plate is of rectangular design, and the force sensors are arranged in the corners of the cover plate. In this case, a rectangular design is also to be understood as one in which the corners of a rectangle are of rounded design. By arranging the force sensors in the corners of the rectangle of the cover plate, it is technically particularly simple to identify pressure points on the cover plate on the basis of the signals from the force sensors. Even when a user activates a pressure point only a few centimeters from the center of the rectangular cover plate, it is possible to identify which operator command a user wishes to trigger on account of the signals of different intensity from the force sensors which are arranged in the four corners of the cover plate. In each case one force sensor is usually arranged in one corner of the cover plate within the scope of this embodiment. However, provision can also be made for no force sensor to be provided in one or more corners of the cover plate but for the cover plate to be suspended, for example flexibly, in these regions, so that the force measurement by the force sensors is possible only in the other corners of the cover plate.

According to an alternative refinement of the invention, at least two, preferably at least three, force sensors can be fitted in the region beneath a, for example round, cover plate. When using a plurality of force sensors, an area between the force sensors is generally detected by means of sensors. When using only two sensors, the detected area shrinks to a line. Pressure points on the cover plate can also be identified in two dimensions by suitably positioning the force sensors—all three sensors must not lie in a line.

On account of the application of the vending machine according to the invention as an outdoor vending machine, a refinement in which the force sensors are designed such that the vending machine can be operated in the standby mode with a current of less than 1 mA is particularly preferred. An energy-saving refinement of the force sensors of this kind is possible, for example, by using electronic sensors such as piezo elements. As a result, power consumption is ultimately restricted virtually to the times at which a user uses the user interface to input operator commands. For the rest of the time, the very low standby current does not serve to operate the force sensors but only the electronic or electrical units which are connected downstream of the force sensors, for example the evaluation electronics system and the assignment and processing units.

According to a first variant of the invention, the cover plate comprises a metal sheet, preferably a steel sheet. This metal sheet preferably has a thickness of up to 2 mm in the region of the force sensors. This means that the steel sheet can have a thickness of up to 2 mm over its entire extent. However, it can also be designed to have this thickness only in the region of the force sensors and to be thicker or thinner in other regions, for example in order to take into account the measuring sensitivities of the force sensors. A cover plate which is designed as a metal sheet primarily ensures optimum protection of the user interface against vandalism. At the same time, force sensors can, especially in the case of the thicknesses indicated here, detect the forces, and therefore generate and output measurement signals without an excessive action of force on the cover plate.

A second variant makes provision for the cover plate to comprise a polycarbonate pane which preferably has a thickness of up to 10 mm in the region of the force sensors. In this case, as in the preceding variants, the thickness of up to 10 mm can be restricted only to the region of the force sensors or the cover plate can be formed with such a thickness overall. The polycarbonate panes used can be, for example, products marketed under the trade names Makrolon® or Lexan®. They have similar resistance properties to metal sheets but with the difference that polycarbonate panes can also be transparent or semitransparent. A transparent design in the form of a polycarbonate pane or another type of transparent pane is particularly preferred in as much as information items can be provided both in front of and behind the cover plate. In this case, a particularly preferred embodiment of a transparent cover plate makes provision for non-variable operator control information items to be provided behind the cover plate. These operator control information items can then be automatically protected by the cover plate too. They can be designed, for example, in the form of replaceable films. Films of this kind can be printed with different information items depending on the area of application, for example depending on the country of use or depending on the customer group.

In addition or as an alternative to non-variable information items, a display for variable information items can be provided behind a transparent cover plate. As a result, the flexibility of the information display is virtually no longer subject to any limits, and therefore protected display information items can be displayed, for example as a function of operator commands. It is also possible to provide information items in different languages by virtue of a language selection means on a display of this kind.

A display of this kind can be in the form, for example, of a screen or LCD display, but also in the form of an electroluminescent film or an LED arrangement.

The cover plate can also be at least partially printed. In the case of a non-transparent cover plate, this can be performed by printing on the front face of the cover plate, which front face faces a user, or, in the case of a transparent cover plate, can also be performed by printing on the rear face of the cover plate, that is to say on the side which is opposite the front face. Partial printings of this kind can also comprise a relief print on the front face, this allowing, for example, vision-impaired people to detect non-variable information items by feel with the aid of Braille characters.

Furthermore, the layer thickness of the cover plate can be reduced in subregions of its front face which faces a user. This can be realized, for example, with the aid of embossed portions—in this case too, it is possible, for example, to emboss haptically detectable Braille text—and/or in the form of relief-like recesses in subregions of the cover plate. Recesses of this kind can, in turn, represent reference points for users and/or represent recesses in the region of the force sensors, as a result of which operator control of the user interface can be improved.

Provision is preferably also made for a moisture seal, for example a flexible silicone insulation means or a flexible rubber seal in the bearing region of the cover plate, to be fitted between the cover plate and a housing of the vending machine. This can prevent moisture or damp entering the inner region of the vending machine via the user interface and, for example, a display which is located behind the cover plate and/or electronic components in the vending machine being damaged by damp or moisture.

A first variant embodiment additionally makes provision for the vending machine to be equipped with a battery for supplying power. This battery can serve as the only power source given a corresponding design of the user interface and further power consumers of the vending machine. Said battery can be designed, for example, as a rechargeable battery and be charged via suitable charging interfaces. A battery supply of this kind can ensure that the vending machine can be operated autonomously and does not have to be coupled to a monitoring and feed system.

The second variant embodiment, which can be used as an alternative or in addition, also allows autonomous operation of a vending machine. Said variant embodiment makes provision for an equipment component with solar cells for supplying power. Since a vending machine according to the invention preferably has a very low level of power consumption, both solar cells and (rechargeable) batteries can supply sufficient power to ensure a reliable supply of power to the vending machine.

The invention will be explained in greater detail in the text which follows with reference to the appended figures on the basis of exemplary embodiments. In this case, the same components are provided with identical reference numerals in the various figures, in which:

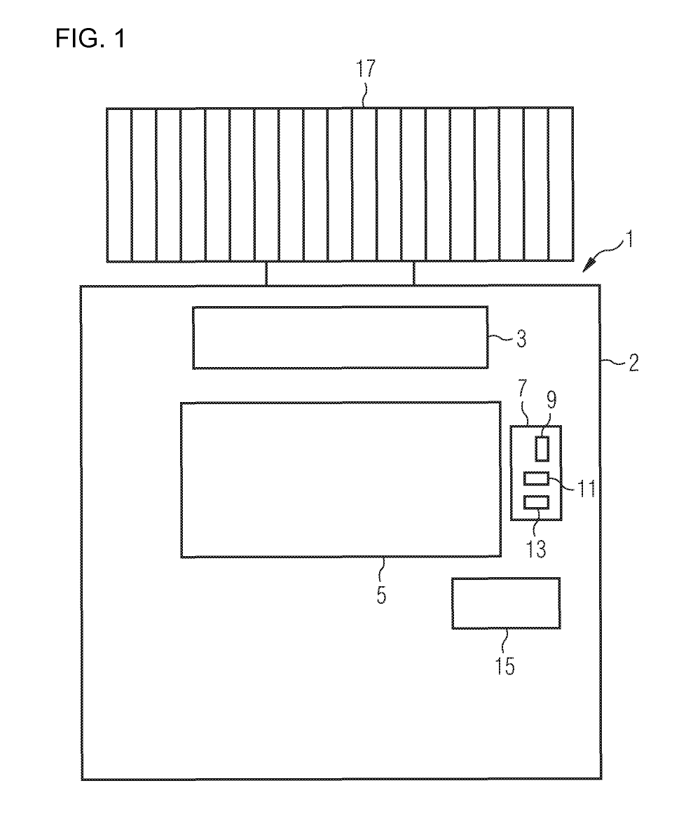

FIG. 1 shows a schematic illustration of a front view of a vending machine according to the invention,

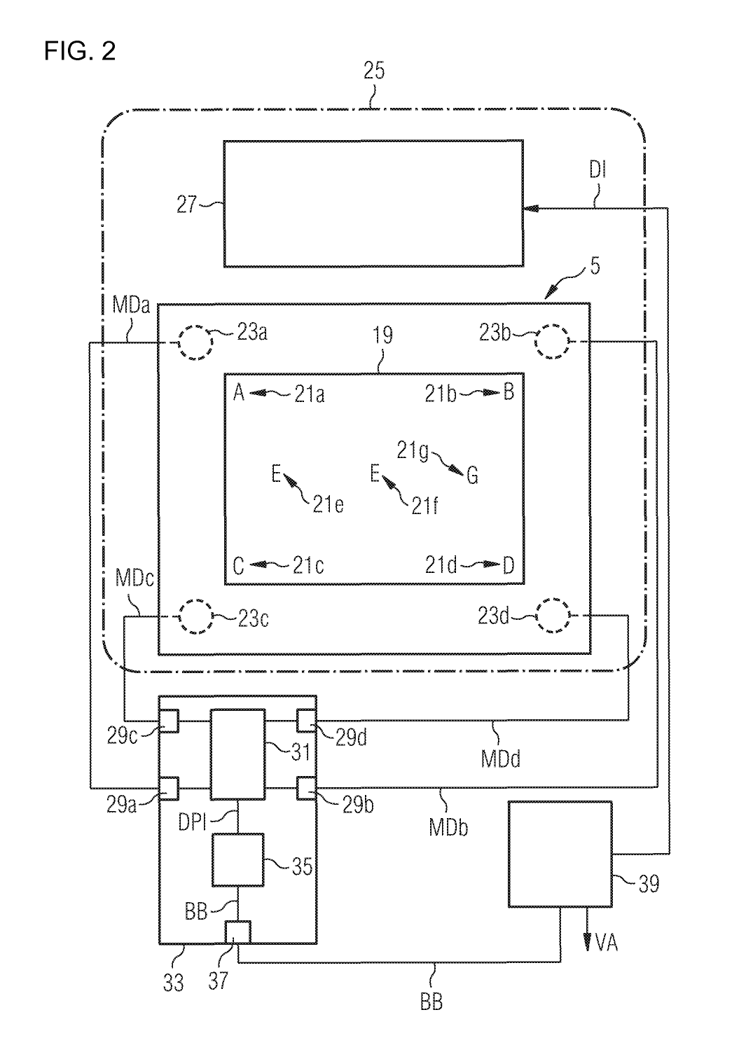

FIG. 2 shows a schematic view of a first refinement of a user interface and a block diagram of an electronics system, which is associated with said user interface, for a vending machine according to the invention, and

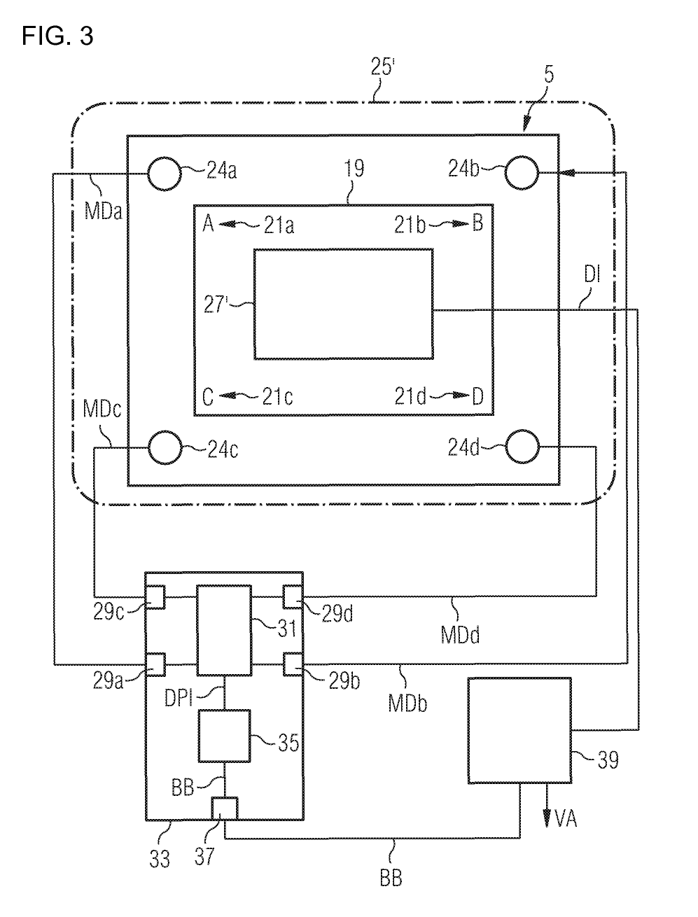

FIG. 3 shows a schematic view of a second refinement of a user interface and a block diagram of an electronics system, which is associated with said user interface, for a vending machine according to the invention.

FIG. 1 illustrates an outdoor vending machine 1 according to the invention. It is supplied with power by solar cells 17 in the upper region of a housing 2 and by a rechargeable battery (not illustrated) for buffer-storing the energy. A display board 3, a cover plate 5, a payment means input region 7 and a dispensing slot 15 are located in the region of the housing 2. The payment means input region 7 for its part comprises a coin slot 9, a bank note slot 11 and a card slot 13. Coins can be inserted into the vending machine 2 via the coin slot 9, bank notes can be inserted into the vending machine via the banknote slot 11, and credit cards or other card-type payment means can be inserted into the vending machine via the card slot 13. The cover plate 5 serves to display operator control information items and at the same time to input operator commands with the aid of pressure on the pressure points. The exact manner of operation of this cover plate is described within the scope of the following figures. The display board 3, for example a printed self-adhesive film, displays general information about the vending machine 1, for example that the vending machine 1 is a parking ticket machine.

FIG. 2 shows a first embodiment of a user interface 25 for an outdoor vending machine 1 and the operator control electronics system, which is coupled to it, in the form of a plurality of electronics units. The user interface 25 has a display 27 for displaying variable information and also comprises a cover plate 5. In the region of the cover plate 5, which is designed as a non-transparent metal plate here, operator control information items 21a, 21b, 21c, 21d, 21e, 21f, 21g which are printed on the front face are located in an information region 19. Four force sensors 23a, 23b, 23c, 23d, which are realized as spring-based sensors here, are located in the region of the corners, behind the rectangular cover plate 5. The operator control information items 21a, 21b, 21c, 21d, 21e, 21f, 21g comprise operator command information items, that is to say those information items which display which operator commands are generated by an assignment unit when a user exerts a force on a pressure point in the region of the respective force sensors 23a, 23b, 23c, 23d. These operator command information items are symbolized here by the letters A, B, C, D, E, F, G. The operator control information items 21a, 21b, 21c, 21d, 21e, 21f, 21g are arranged such that their contents correspond to the operator commands which are generated by exerting a force on the cover plate 5 in the regions of the operator control information items 21a, 21b, 21c, 21d, 21e, 21f, 21g with the aid of the evaluation electronics system 33 described below. The signals MDa, MDb, MDc, MDd generated by the force sensors 23a, 23b, 23c, 23d are fed to an evaluation electronics system 33. The evaluation electronics system 33 comprises input interfaces 29a, 29b, 29c, 29d for receiving the signals MDa, MDb, MDc, MDd and also a pressure point determination unit 31 and an assignment unit 35. An output interface 37 for forwarding operator commands BB is also provided in the evaluation electronics system 33. These operator commands BB arrive at a processing unit 39 which executes sales actions VA during operation on the basis of these operator commands BB. The processing unit 39 also sends display information DI to the display 27, which can, for example, display which sales action is selected by the user.

In order to operate the outdoor vending machine 1, a user reads the information items on the display 27 and in the information region 19 and then presses a pressure point on the cover plate 5, for example in the top-left region of the cover plate 5, in which the operator control information item 21a is provided, with which an operator command “A” is associated. As a result, a respective signal MDa, MDb, MDc, MDd is generated by the force sensors 23a, 23b, 23c, 23d. The intensity of these signals MDa, MDb, MDc, MDd varies as a function of the distance of the force sensors 23a, 23b, 23c, 23d which generate said signals from the pressure point. In the example selected here, a signal MDa which is generated by the force sensor 23a is considerably stronger than a signal MDd which is generated by the force sensor 23d. The signals MDb, MDc, which are generated by the force sensors 23b and 23c, lie in the region between the intensity of the signals MDa, MDd from the force sensor 23a and from the force sensor 23d. These signals MDa, MDb, MDc, MDd arrive at the pressure point determination unit 31 via the input interfaces 29a, 29b, 29c, 29d of the evaluation electronics system 33. In said pressure point determination unit, the region of the cover plate 5 in which the pressure point was situated is determined, that is to say in the top-left region of the cover plate 5 in the present example. These pressure point information items DPI are fed to the assignment unit 35 which derives an operator command BB from said information items. This operator command BB corresponds to the operator command information which is displayed in the information region 19 for the region of the operator control information items 21a, 21b, 21c, 21d. In the present example, the operator command “A” which is assigned to the operator control information item 21a would therefore be generated by the assignment unit 35. In contrast, an operator command “F” would be generated when a user exerts a force on the front face of the cover plate 5, which front face faces the user, approximately in the center of the cover plate 5. The force sensors 23a, 23b, 23c, 23d would, for example, transmit an identical signal in this case, the evaluation electronics system 23 deriving the operator command “F” from this signal. When the user presses the region of the operator control information item 21g which is arranged in the center-right region between the operator control information items 21b and 21d which are arranged in the right-hand corners, the same signals are, in contrast, measured by in each case two force sensors: the two left-hand force sensors 23a, 23c measure an approximately identical weaker signal; the two right-hand force sensors 23b, 23d measure an approximately identical stronger signal. The evaluation electronics system 23 derives the operator command “G” from this signal. The same applies in reverse for triggering the operator command “E”. In the above-described user interface 25, the pressure points on the cover plate 5 can be triggered with an accuracy of +/−2.5 mm with the currently available means.

The operator commands BB arrive at the processing unit 39 via the output interface 37, said processing unit deriving and executing sales actions VA from said operator commands. Sales actions VA of this kind include, for example, printing of a parking ticket. A display information item DI is correspondingly displayed in the display 27, said display information containing the information that a certain sales amount is due before the parking ticket is dispensed. This sales amount can be paid by inserting coins, bank notes or inserting a credit card into the payment means input region 7 (see FIG. 1).

FIG. 3 shows a second embodiment of a user interface 25′. The difference from the user interface 25 shown in FIG. 2 is essentially that a display 27′ for displaying variable information is arranged in the region of the cover plate 5 behind the cover plate 5. The cover plate 5 is a transparent polycarbonate pane. A printed film is placed behind said polycarbonate pane as an information region 19 which has a cutout in the region of the display 27′. In this arrangement, both variable and non-variable operation control information items are arranged in the region behind the cover plate 5 such that they are protected. Furthermore, force sensors are again arranged behind the cover plate 5, but these force sensors are designed as piezo elements 24a, 24b, 24c, 24d in this case.

To conclude, it should once again be noted that the outdoor vending machine and the user interface described in detail above are merely exemplary embodiments which can be modified by a person skilled in the art in a wide variety of ways, without departing from the field of the invention. Furthermore, the use of the indefinite article “a” does not preclude the possibility of two or more of the features in question being present.

1-15. (canceled)

16. An outdoor parking meter, comprising:
a vending machine housing and a battery for supplying power;
a user interface with a cover plate mounted to said housing, operator control information items associated with said cover plate, and force sensors coupled to said cover plate, said force sensors emitting signals in response to an exertion of an external force on said force sensors by way of said cover plate, and said force sensors being configured to enable said parking meter to be operated in a standby mode with a current of less than 1 mA;
an evaluation electronics system connected to receive the signals from said force sensors and having a pressure point determination unit for identifying pressure points on said cover plate on a basis of the signals from said force sensors;
an assignment unit assigning different operator commands to different pressure points during operation; and
a processing unit connected to said assignment unit, said processing unit executing sales actions during operation on a basis of the operator commands;
wherein said operator control information items include operator command information items each at least partly located in or on a pressure region on said cover plate, and the pressure region having a pressure point being activated by touch and said assignment unit assigns to said pressure point operator commands that correspond to the operator command information items.

17. The parking meter according to claim 16, wherein said cover plate has a rectangular outline with corners, and said force sensors are disposed in said corners of said cover plate.

18. The parking meter according to claim 16, wherein said cover plate comprises a metal sheet.

19. The parking meter according to claim 18, wherein said metal sheet is a steel sheet having a thickness of up to 2 mm in a region of said force sensors.

20. The parking meter according to claim 16, wherein said cover plate comprises a polycarbonate pane.

21. The parking meter according to claim 20, wherein said polycarbonate pane has a thickness of up to 10 mm in a region of said force sensors.

22. The parking meter according to claim 16, wherein said cover plate is transparent.

23. The parking meter according to claim 22, which comprises non-variable operator control information items disposed behind said cover plate.

24. The parking meter according to claim 22, which comprises a display for variable information disposed behind said cover plate.

25. The parking meter according to claim 16, wherein said cover plate is at least partially printed.

26. The parking meter according to claim 16, wherein a layer thickness of said cover plate is reduced in subregions of a front face thereof facing a user.

27. The parking meter according to claim 16, which comprises a moisture seal fitted between said cover plate and said vending machine housing.

28. The parking meter according to claim 16, which comprises solar cells for supplying power.

29. In combination with a battery-powered parking meter, a user interface, comprising:
a cover plate having operator control information items associated therewith and force sensors coupled to said cover plate;
said force sensors emitting signals in response to an external force exerted thereon by way of said cover plate;
an evaluation electronics system with a pressure point determination unit for identifying pressure points on said cover plate on a basis of the signals from said force sensors; and
said force sensors being configured to enable the parking meter to be operated in a standby mode with a current consumption of less than 1 mA.
